(19) United States
(12) Patent Application Publication
(10) Pub. No.: US 2005/0034905 A1
(43) Pub. Date: Feb. 17, 2005

(54) Industrial truck with an electrical drive, a fuel cell system and a heating device for an operator's position

(75) Inventors: Lars Gunther, Rheine (DE); Torsten Leifert, Vogelsen (DE)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: STILL GmbH

(21) Appl. No.: 10/887,240

(22) Filed: Jul. 7, 2004

(30) Foreign Application Priority Data
Jul. 8, 2003 (DE) 103 30 816.4

(51) Int. Cl. B60L 11/18; H01M 8/04

(52) U.S. Cl. 180/65.3; 429/26

(57) ABSTRACT

An industrial truck has an electrical drive (6), a fuel cell system (1), and a heating device for an operator's position. The heating device can be operated utilizing the heat that is generated during the operation of the fuel cell system (1).

### CROSS REFERENCE TO RELATED APPLICATION

This application claims priority to German Application No. 103 30 816.4 filed Jul. 8, 2003, which is herein incorporated by reference in its entirety.

### BACKGROUND OF THE INVENTION

1. Field of the Invention

This invention relates to an industrial truck with an electrical drive, a fuel cell system, and a heating device for an operator's position.

2. Technical Considerations

Industrial trucks are used for the internal transport of goods in a plant or warehouse. When industrial trucks must be operated in enclosed spaces, industrial trucks with electrical drives are generally used because they do not produce any harmful emissions. Fuel cells are increasingly being used as the energy source for industrial truck drive systems, among other things, on account of their high efficiency.

When industrial trucks are operated in a cold environment, for example in a refrigerated room or outdoors, they frequently include heating devices for the operator's position. These devices can heat the entire driver's cab, for example, or only individual elements with which the operator comes into contact during operation of the industrial truck, such as, for example, control components, and in particular steering wheels or tow bars, handles and seats. Electric resistance heater systems have long been used, in particular for battery-operated industrial trucks, and are, therefore, available at economical prices. One disadvantage of these resistance-heater systems is their high energy consumption. The result is a reduced operating time as well as the fact that the truck, or at least the battery, must be taken out of operation for long periods to recharge the energy supplies.

Therefore, it is an object of the invention to provide an industrial truck with an electrical drive and a fuel cell system that has a suitable heating device with a lower energy consumption for an operator's position.

### SUMMARY OF THE INVENTION

The invention teaches that a heating apparatus can be operated using the heat that is generated during the operation of the fuel cell system. The waste heat of the fuel cell system conventionally escapes unused or can also be discharged via a cooling system. As a result of the operation of the heating device using the waste heat of the fuel cell system, complex and expensive electrical heating devices that consume additional electrical energy become unnecessary.

In one advantageous realization of the invention, the medium that transmits the heat is a fluid, such as a liquid, such as but not limited to water. Cooling systems of the known art for fuel cells are frequently based on liquid cooling, in particular water. A heating device can be integrated into the system easily, with little effort and at little expense.

In another advantageous realization, the medium that transmits the heat is a gas, such as but not limited to air. In particular when heating closed cabs, the injection of warm air is a method that guarantees an effective delivery of heat.

In an additional embodiment, the medium that transmits the heat is the exhaust gas from the fuel cell. The exhaust gas is also heated and can thus be utilized to deliver heat to the driver's position.

It is further advantageous if at least one operator's position can be heated by the heating device. The operator's position is the area of the industrial truck where the operator is frequently located. The temperature in this location should, therefore, be as comfortable as possible for the operator.

At least one operating element, for example a steering device, can be advantageously heated. Operating elements are touched directly and frequently by the operator with unprotected hands, and should thereby be at a comfortable temperature.

It is advantageous if at least one driver's seat can be heated. A temperature that is pleasant for the operator is created even in open operator's positions, which is advantageous if the operator is required to climb in and out of the vehicle frequently.

In an additional advantageous realization, the operator's position is a driver's cab. When the industrial truck is operated primarily in a cold environment, the operator's position is thereby better protected against the cold environment and less heating output is required. When the fuel cell is turned off for short periods of time, a temperature that is pleasant for the operator can be maintained for a sufficient length of time.

### BRIEF DESCRIPTION OF THE DRAWINGS

Additional advantages and details of the invention are explained in greater detail below with reference to the exemplary embodiment illustrated in the accompanying schematic figures, in which like reference symbols identify like parts throughout.

FIG. 1 is a schematic illustration of the energy supply of an industrial truck of the invention with a hot air blower; and

FIG. 2 is a schematic illustration of the energy supply of an industrial truck of the invention with hot water heating.

### DESCRIPTION OF THE PREFERRED EMBODIMENTS

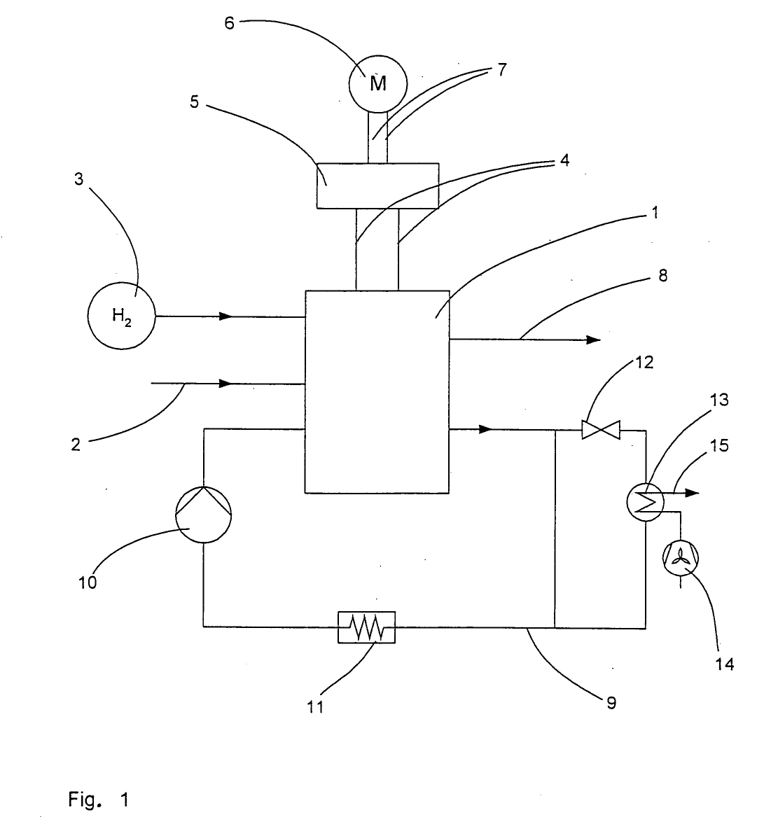

FIG. 1 is a schematic illustration of the energy supply of an industrial truck of the invention utilizing a conventional hot air blower. A fuel cell system 1 is supplied with ambient air via a feed line 2. Hydrogen fuel is supplied from a reservoir 3. The current generated in the fuel cell system is conducted by means of the lines 4 to an electrical control unit 5, from which the individual consumers, represented in the illustrated embodiment by an electrical drive motor 6, are supplied with electrical energy via the lines 7. During the operation of the fuel cell system 1, the oxygen contained in the atmospheric air fed into the system is converted into water with the hydrogen that is supplied from the reservoir 3. This water is present in the form of water vapor in the exhaust air, which is discharged to the atmosphere via the line 8. The fuel cell system 1 is cooled by a cooling circuit 9 in which a pump 10 transports water through the fuel cell system 1. The heat absorbed by the cooling water is discharged to the atmosphere via the radiator 11.

However, in the practice of the invention, by means of a valve 12, a heat exchanger 13 is connected to the cooling circuit 9 to which air is delivered by an air blower 14. The heated air is transported via a line 15 to the operator's position (not shown here). In this case, the operator's position can be considered the area of the industrial truck or the area in the immediate vicinity of the industrial truck in which an operator is located during the operation of the industrial truck to operate the functions of the industrial truck. This area can be, for example, an enclosed or open cab with a driver's seat, a platform for the operator to stand on, or the area from which the tow bar of a lift truck can be operated.

The amount of heat put out by the heater can be controlled by the amount of cooling water that is fed to the heat exchanger 13, which can be regulated by means of the valve 12, as well as by means of the amount of air that is delivered by the air blower 14. These variables can be regulated automatically as in the known art for conventional hot-air heaters that are heated using liquids, or manually by a pre-selection by the operator of the desired amount of heat. The operation and control of such conventional hot-air heaters will be well understood by one of ordinary skill in the art and, therefore, will not be discussed in detail.

The heated air can be discharged in the operator's position through outlets and can thus be used, for example, to heat a driver's cab. The heat can also be transported through one or more control elements or into a driver's seat to heat them. This latter method is particularly advantageous in vehicles with an open operator's position.

In fuel cell systems that are operated with hydrogen, the exhaust gas consists primarily of heated air that has an elevated concentration of water vapor and a reduced concentration of oxygen. In driver's positions that have sufficient air circulation, this air can be used either directly or it can also be mixed with ambient air for heating via air outlet openings. It is also within the scope of the invention that the current of exhaust gas can be transported through a driver's seat or through one or more of the control elements. The temperature can thereby be regulated as in the known art, for example, by regulating the air flow or by adding cooler outside air.

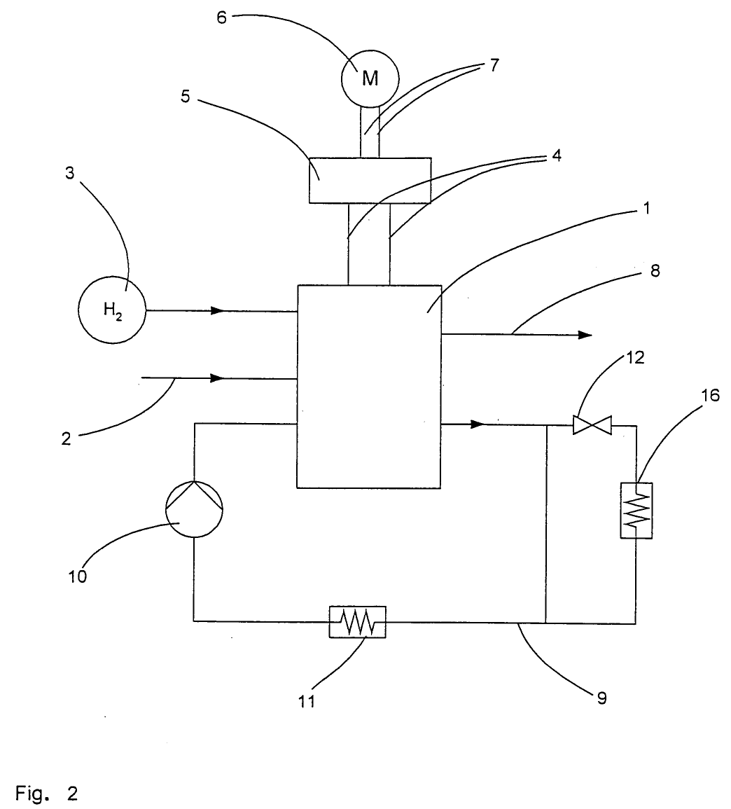

FIG. 2 illustrates an additional exemplary embodiment of the invention. Items that are identical to the items shown in FIG. 1 are identified by the same reference numbers. Instead of heating air by means of the heat exchanger 13, the coolant fluid is used directly to heat the operator's position by means of the heating element 16. For this purpose, the flow of hot liquid can be conducted through the floor or walls of a driver's cab, for example, to thereby achieve the transmission of heat to the operator's position. It is also within the scope of the invention that the driver's seat or one or more of the control elements can be heated directly. In this case, the heat can be regulated as in the known art for conventional hot water heating systems, for example, by means of the valve 12.

Of course, a combination of the possible configurations described above can also be used to supply the heating device with heat.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

1. An industrial truck, comprising:
an electrical drive;
a fuel cell system; and
at least one heating device for at least one operator's position,
wherein the heating device is operated by heat generated during operation of the fuel cell system.

2. The industrial truck as claimed in claim 1, wherein a medium transporting the heat to the heating device comprises a liquid.

3. The industrial truck as claimed in claim 2, wherein the liquid medium is water.

4. The industrial truck as claimed in claim 1, wherein a medium transporting the heat to the heating device comprises a gas.

5. The industrial truck as claimed in claim 4, wherein the gaseous medium is air.

6. The industrial truck as claimed in claim 1, wherein a medium transporting the heat to the heating device comprises exhaust gas from the fuel cell.

7. The industrial truck as claimed in claim 1, wherein more than one operator's position is heated by the at least one heating device.

8. The industrial truck as claimed in claim 1, wherein at least one control element is heated by heat generated by operation of the fuel cell system.

9. The industrial truck as claimed in claim 8, wherein the at least one control element is a steering device.

10. The industrial truck as claimed in claim 1, wherein at least one driver's seat is heated by heat generated during operation of the fuel cell system.

11. The industrial truck as claimed in claim 1, wherein the operator's position is a driver's cab.

12. The industrial truck as claimed in claim 2, wherein at least one control element is heated by heat generated by operation of the fuel cell system.

13. The industrial truck as claimed in claim 2, wherein at least one driver's seat is heated by heat generated during operation of the fuel cell system.

14. The industrial truck as claimed in claim 4, wherein at least one control element is heated by heat generated by operation of the fuel cell system.

15. The industrial truck as claimed in claim 4, wherein at least one driver's seat is heated by heat generated during operation of the fuel cell system.

16. The industrial truck as claimed in claim 6, wherein at least one control element is heated by heat generated by operation of the fuel cell system.

17. The industrial truck as claimed in claim 6, wherein at least one driver's seat is heated by heat generated during operation of the fuel cell system.

18. The industrial truck as claimed in claim 2, wherein the operator's position is a driver's cab.

19. The industrial truck as claimed in claim 4, wherein the operator's position is a driver's cab.

20. The industrial truck as claimed in claim 6, wherein the operator's position is a driver's cab.
